(19) United States
(12) Patent Application Publication
(10) Pub. No.: US 2024/0118132 A1
(43) Pub. Date: Apr. 11, 2024

(54) SYSTEM FOR DETECTING ELECTROMAGNETIC RADIATION AND COOLING METHOD

(71) Applicant: LYNRED, Palaiseau (FR)

(72) Inventors: Pierre CASSAIGNE, Grenoble (FR); Eric FRENE, Noyarey (FR)

(73) Assignee: LYNRED, Palaiseau (FR)

(21) Appl. No.: 18/275,886

(22) PCT Filed: Feb. 10, 2022
(86) PCT No.: PCT/EP2022/053300

§ 371 Date: Aug. 4, 2023

(30) Foreign Application Priority Data
Feb. 10, 2021 (FR) FR2101286

(51) Int. Cl. G01J 1/02

(52) U.S. Cl. CPC G01J 1/0252

(57) ABSTRACT

An electromagnetic radiation detection system includes a detection circuit detecting an electromagnetic radiation and supplying a representative electrical signal. A cold table supports the detection circuit. A thermally insulating support supports the cold table. It includes an enclosure defining a closed volume and provided with a bottom, a top and a side wall connecting the bottom and the top. The thermally insulating support mechanically connects the cold table with the bottom of the enclosure. A cooler is mechanically connected to the enclosure and configured to cool the detection circuit. The cooler is mechanically fastened onto the side wall of the enclosure and thermally connected to the detection circuit by means of a thermal connector connecting the cooler and the cold table and the cold shield.

### BACKGROUND OF THE INVENTION

The invention relates to a system for detecting electromagnetic radiation and to a method for cooling an electromagnetic radiation detection system.

### PRIOR ART

In a large number of technical fields, it is conventional to observe a scene by means of an electromagnetic radiation detection system and preferentially an infrared radiation detection system.

The detection system is a cooled detection system, i.e. a detection system that is equipped with a cooler. The cooler is configured to cool the electronic device that captures the electromagnetic radiation to improve its electro-optical performances.

In conventional manner, the detection circuit forms a focal plane array that is associated with a cold shield to channel the electromagnetic radiation to be received. The cold shield is a hollow element of tubular or substantially tubular shape and is capped by an optical function. The detection circuit and cold shield are installed on a cold table and all these elements are mechanically and thermally connected so that they have to be cooled by a cooler.

The detection circuit, cold shield and cold table are arranged inside a cryostat. The cooler is physically connected to the bottom of the cryostat and more precisely to the cold finger that supports the cold table. The cooler is thermally connected to the cold table to perform cooling of the latter. The detection circuit is cooled by means of the cooler via the cold table.

The cooling power is applied to the inside of the volume delineated by the cold finger and the cold table. In certain configurations, the cold finger is a tube open at both ends and the cold table is fixed so as to ensure the tightness of the connection. The cryogenic gas applied must not escape to the cryostat at low pressure. In other configurations, the cold finger is closed at its top end which improves the tightness but introduces an additional thermal resistance between the cooling power supplied by the cooler and the detection circuit to be cooled placed on the cold table.

In prior art configurations, the cooler, cold table, detection circuit and optical function are aligned along an axis that corresponds or substantially corresponds to the optical axis of optical system. The cold finger supports the cold table which imposes a great stiffness to prevent the detection circuit from moving inside the cryostat when abrupt movements imposed on the detection system occur. It is also important for the cold finger to be very thermally insulating on its side wall to prevent thermal losses to the cryostat that is at a higher temperature. The top of the cold finger is thermally connected to the cooler and to the cold table and is at low temperature. On the contrary, the foot of the cold finger is connected to the cryostat and is at high temperature.

This technical solution presents a certain number of drawbacks and in particular it imposes large constraints on the cold finger as regards the choice of usable materials and as regards its dimensions and engineering.

Document US2011/0005238 presents a substantially similar configuration to the previous one with a cold table that supports a detection circuit to be cooled and a cold shield. This assembly is installed inside an enclosure that is at low pressure. A cryostat of tubular shape is used with a cryogenic gas. The cryostat forms a cold finger that secures the cold table with respect to the enclosure. The cold finger is subjected to the same constraints as the prior art. The cold finger is tightly sealed by a cold bridge that mechanically and thermally connects the end of the cold finger and the cold table. The cold bridge forms a peripheral ring at the surface of the cold table and performs fixing of the cold shield.

Unlike the previous configuration, the cold finger does not connect on the bottom face of the cold table but on the face that supports the detection circuit. The cold finger is then considerably offset with respect to the optical axis which introduces an assembly with a large cantilever detrimental to a good mechanical strength and to a good control of the position of the optical axis when the detection system moves. To overcome this drawback, a second cold finger is fixed to the cold bridge to cool the cold table and the cold shield. This technical solution does not solve the technical problems set out above as it is still necessary to have a cold finger that is thermally insulating and mechanically very rigid. This configuration is more difficult to achieve as it requires having cold fingers having almost identical dimensions, that deform in similar manner with the temperature and that work at the same temperature to avoid phenomena of differential expansion and therefore of offset of the optical axis according to the temperature.

### OBJECT OF THE INVENTION

One object of the invention consists in providing an electromagnetic radiation detection system that presents better performances than the prior art configurations and in particular by relaxing the constraints imposed on the thermomechanical performances of the thermally insulating support. This result tends to be achieved by means of an electromagnetic radiation detection system that comprises:
a detection circuit configured to detect an electromagnetic radiation and to supply an electrical signal representative of the detected electromagnetic radiation,
a cold table supporting the detection circuit,
a thermally insulating support supporting the cold table,
a cryostat provided with a bottom, a top and at least one side wall connecting the bottom and the top, the cryostat defining a closed volume, the thermally insulating support mechanically connecting the cold table with the bottom of the cryostat,
a cooler mechanically connected to the cryostat and configured to cool the detection circuit.

The electromagnetic radiation detection system is remarkable in that the cooler is mechanically fastened onto the at least one side wall of the cryostat and thermally connected to the detection circuit by means of a thermal connector connecting the cooler and at least one of the cold table and the cold shield.

In a particular embodiment, the deformable thermal connector comprises a first end fixed to the cooler and a second end fixed to the cold table or to the cold shield.

In advantageous manner, the at least three areas are successively an area on the at least one side face and extends only facing the area of the pulp casing.

Preferentially, the second end is fixed to a central part of the cold shield, the central part extending from the bottom third to the top third of the cold shield along an optical axis of an electromagnetic radiation detection assembly formed by the detection circuit and the cold shield.

In a particular embodiment, the cooler has a first end capped by a salient stud, the thermal connector being attached to the salient stud. The salient stud of the cooler is fitted salient from the inner surface of the side wall of the cryostat.

In a preferred embodiment, the thermal connector is a deformable thermal connector.

In advantageous manner, the deformable thermal connector is chosen from a spring, a braid, a knit, a fabric, a gusset, a piston or at least a metal wire.

In a particular embodiment, an additional cooler is fastened to the at least one side wall of the cryostat and an additional thermal connector thermally connects one end of the additional cooler and the top of the cold shield, the thermal connector being fixed to the cold table or in the bottom half of the cold shield extending from the cold table.

It is advantageous to provide for the cooler to be a Stirling cooler.

Preferentially, the thermal conductivity of the thermally insulating support is lower than the thermal conductivity of the thermal connector.

In an advantageous embodiment, the thermally insulating support is apertured and/or the connection between the thermally insulating support and the cold table is not tightly sealed.

It is a further object of the invention to provide a method for cooling an electromagnetic radiation detection system comprising the following steps:
providing an electromagnetic radiation detection system according to one of the foregoing configurations,
activating the cooler to cool the detection circuit.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically represents a first embodiment of an electromagnetic radiation detection system;

FIG. 2 schematically represents a second embodiment of an electromagnetic radiation detection system.

### DESCRIPTION OF THE EMBODIMENTS

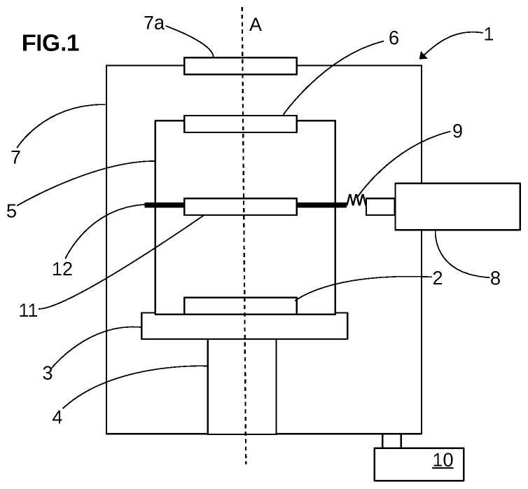

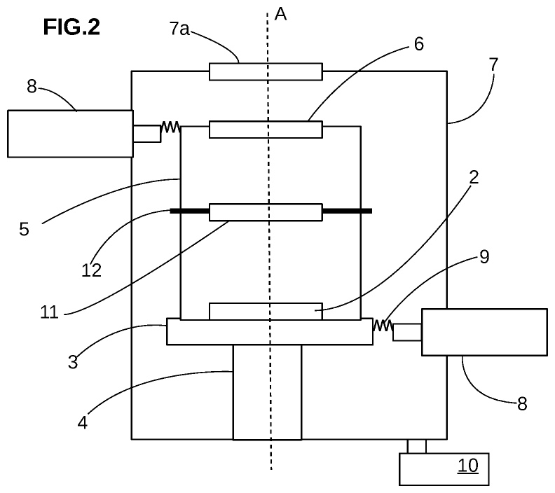

FIGS. 1 and 2 illustrate different embodiments of an electromagnetic radiation detection system 1 that comprises a detection circuit 2 configured to detect electromagnetic radiation and to supply an electrical signal representative of the received radiation. Detection circuit 2 captures an electromagnetic signal in a wavelength range of interest and transforms this electromagnetic signal into an electrical signal. In a particular embodiment, the captured electromagnetic radiation is an infrared radiation. The electrical signal supplied is a voltage signal or a current signal.

In a particular embodiment, detection circuit 2 is formed by two different substrates hybridized on one another. The first substrate has one or more photodetectors that capture the electromagnetic signal to transform it into an electrical signal. The second substrate comprises one or more readout circuits that perform storage and/or a first processing of the electrical signal. The electrical signal is then transmitted to a processing circuit that will process the electrical signal.

Electromagnetic radiation detection system 1 comprises a cold table 3 that supports detection circuit 2 and a thermally insulating support 4 that supports cold table 3.

Electromagnetic radiation detection system 1 comprises a cold shield 5 a first end of which, called bottom end, is fixed to cold table 3. The connection between cold shield 5 and cold table 3 surrounds the portion of the detection circuit that captures the electromagnetic radiation. Cold shield 5 has a foot that is fixed to cold table 3 or to the detection circuit and a top that has a first optical function 6. Cold shield 5 has at least one side wall connecting the foot and the top. The at least one side wall blocks the electromagnetic radiation in the wavelength range captured by detection circuit 2. The electromagnetic radiation captured by the detection circuit passes through first optical function 6. Cold table 3 and cold shield 5 form an opaque enclosure so that the radiation designed to reach the detection circuit is exclusively the radiation that passed through first optical function 6.

First optical function 6 lets at least a part of the received electromagnetic radiation pass. The first optical function is preferentially chosen from a lens and an optical filter. The lens lets at least 90% of the electromagnetic radiation pass and focuses the electromagnetic radiation. The optical filter is configured to block a part of the received signal, for example to block a spectral waveband higher than or lower than a cutoff wavelength.

Electromagnetic radiation detection system 1 comprises a cryostat 7. Cryostat 7 comprises a bottom, a top and at least one side wall that connects the bottom and the top. Cryostat 7 forms a closed, leaktight enclosure. Cold table 3, detection circuit 2 and cold shield 5 are arranged inside cryostat 7. The top of cryostat 7 has a second optical function 7a. Second optical function 7a enables the electromagnetic radiation to enter cryostat 7. In preferential manner, cryostat 7 forms an enclosure opaque to the electromagnetic radiation designed to be captured by detection circuit 2 so that the captured electromagnetic radiation is passed through second optical function 7a.

Thermally insulating support 4 supports cold table 3 and has a first end fixed to cryostat 7 and a second end fixed to cold table 3. Cold table 3 is mechanically supported by cryostat 7 by means of thermally insulating support 4. Cold table 3 is mounted immobile with respect to cryostat 7. Thermally insulating support 4 thermally insulates cold table 3 and cryostat 7. The thermally insulating support forms a first mechanical connection between the wall of cryostat 7 and cold table 3. The first mechanical connection is a rigid mechanical connection to fix the position of cold table 3 inside cryostat 7.

A cooler 8 is mounted on the at least one side wall of cryostat 7. Cooler 8 is thermally connected to detection circuit 2 so as to cool detection circuit 2. Preferentially, cooler 8 is configured so that detection circuit 2 operates at a temperature lower than 200K and preferentially at a temperature lower than 150K. Cooler 8 is fixed directly on the side wall of cryostat 7. The cold area of cooler 8 is not in thermal contact with cryostat 7 to prevent a loss of cooling power to the side wall of cryostat 7.

Cooler 8 is thermally connected to cold shield 5 and/or to cold table 3 by a thermal connector 9. Thermal connector 9 provides cooling energy to detection circuit 2 to lower its temperature and improve its electro-optical performances. Thermal connector 9 is distinct from thermally insulating support 4. Thermal connector 9 defines a second mechanical connection between cooler 8 and the assembly formed by cold table 3 and cold shield 5. The second mechanical connection is less rigid than the first mechanical connection which enables cooler 8 and the assembly formed by cold table 3 and cold shield 5 to be mechanically dissociated. It is preferable to form a flexible connection, for example by means of a flexible element.

Thermal connector 9 is not thermally and mechanically associated with thermally insulating support 4 as is the case in the configurations of the prior art. Thermal connector 9 is distinct from thermally insulating support 4 to enable detection circuit 2 to be cooled without making the calories transit via thermally insulating support 4 as in the prior art. Thermal connector 9 is fastened onto cold shield 5 or onto cold table 3. Thermal connector 9 can be connected on the front face of the cold table receiving the detection circuit, on the side face of cold table 3 or possibly on the rear face. It is advantageous to fasten the thermal connector onto the front face or onto the side face.

Whereas in the configurations of the prior art, thermally insulating support 4 simultaneously performs the function of mechanical support of cold table 1, of thermal insulation between cold table 3 and the foot of thermally insulating support 4, and creation of the cooling source, the configuration according to the invention dissociates these functions by modifying the arrangement of cooler 8 with respect to cryostat 7 and to thermally insulating support 4.

Mechanical support of cold table 3 is dissociated from cooling of cold table 3 which enables the engineering constraints on thermally insulating support 4 to be relaxed. It is, for example, possible to use materials that are mechanically more rigid and/or architectures that increase the rigidity of thermally insulating support 4 to reduce the movements of cold table 3 with respect to cryostat 7. A greater freedom exists as regards the usable materials and the architectures available to form a rigid thermally insulating support 4.

The inside of cryostat 7 is subjected to a low pressure by means of a pump 10. Pump 10 can be connected to cryostat 7 by means of a pipe that opens out for example in the bottom or on the at least one side wall. Thermal connector 9 enables heat to be removed or cold to be input to the detection circuit by conduction inside the cryostat in a vacuum. For example, the pressure inside the cryostat is less than 30 mbar, preferentially less than 5*10⁻³ mbar.

Cooler 8 does not provide the coolant via the internal part of thermally insulating support 4 which relaxes the constraints on maintaining the pressure difference between the inside of thermally insulating support 4 that was subjected to a pressure of several bars and the outside of the thermally insulating support that was subjected to a pressure of a few mbars. In preferential manner, the pressure is identical between the inside of the thermally insulating support and the outside of the thermally insulating support which enables the thermally insulating support 4 to be less mechanically stressed. New materials and/or new shape of thermally insulating supports 4 are thus possible. The mechanical performances related to the rigidity of the thermally insulating support and also its thermal resistivity can be improved. As illustrated, thermally insulating support 4 does not form part of the cooler or of any cooler.

In a particular embodiment, thermally insulating support 4 is apertured thereby reducing the thermal conductivity between the foot and the top of thermally insulating support 4, and also the mechanical mass and thermal mass. Such a configuration is incompatible with detection systems of the prior art that provide the coolant via the inside of thermally insulating support 4.

As it is no longer necessary to have a connection area between cold table 3 and thermally insulating support 4 that is tightly sealed, as an alternative or in combination with the previous embodiment, the bottom face of cold table 5 can be textured or the top face of the thermally insulating support can be textured to define through holes between the cold table and thermally insulating support 4. Texturing of the bottom face of cold table 5 for example makes it possible to improve the trade-off between mechanical rigidity and thermal mass.

It is also possible to provide for the mechanical connection between cold table 3 and thermally insulating support 4 not to be tightly sealed. This enables the contact points between thermally insulating support 4 and cold table 3 to be reduced thereby reducing the loss of cooling energy through thermally insulating support 4.

Installation of cooler 8 on the at least one side wall of cryostat 7 reduces the dimensions of detection system 1 along optical axis A represented in FIGS. 1 and 2. By offsetting cooler 8 onto the side wall of the cryostat, the mechanical stresses imposed on cryostat 7, and in particular on its rigidity, are reduced. It is then possible to produce a cryostat presenting better thermal performances which enables its size and therefore the overall dimensions of detection system 1 to be reduced.

Thermal connector 9 is made from a good thermal conducting material, for example a metal and more preferentially a metal chosen from gold, silver and copper. The metal can also be any pure metal or any alloy that has a higher thermal conductivity than the conductivity of copper below 200K.

In preferential manner, the thermal conductivity of thermal conductor 9 is higher than the thermal conductivity of thermally insulating support 4.

In preferential manner, cooler 8 is thermally connected to detection circuit 2 by means of a deformable thermal connector 9, for example a flexible thermal connector.

Deformable thermal connector 9 does not form a rigid mechanical connection between detection circuit 2 and cooler 8. Deformable thermal connector 9 forms a flexible and indirect mechanical connection between cooler 8 and detection circuit 2. The flexible thermal connector forms a deformable mechanical connection between cooler 8 and the assembly formed by cold table 3, detection circuit 2 and cold shield 5. Although cold table 3 is mounted immobile in cryostat 7, the use of a deformable thermal connector reduces the mechanical stress that may exist between cooler 8 and the assembly formed by cold table 3, detection circuit 2 and cold shield 5 when a rigid mechanical connection is formed. The use of a deformable thermal connector prevents for example application of a force causing an offset of the first optical function and/or of the second optical function with respect to the optical axis.

In a particular embodiment, the effective length of the deformable thermal connector is adjusted between the end of thermal connector 9 fixed to cooler 8 and the opposite end fixed to cold table 3 or to cold shield 5. This adjustment of the effective length makes it possible to compensate a modification of the distance between the wall of cryostat 7 and table 3 or cold shield 5 when a temperature change takes place, for example to take account of a thermal expansion coefficient difference. Such a phenomenon may occur when cooling is performed. Adjustment of the effective length enables a modification of the distance between the cryostat and table 3 or cold shield 5 to be compensated, for example when an abrupt movement occurs. This prevents deformation of the side wall of the cryostat from applying a large stress on cold table 3 and/or on cold shield 5.

The use of a deformable thermal connector 9 is particularly advantageous when the cooler is a Stirling cooler that is known as such and uses expansion and compression steps of a gas to cool detection circuit 2. The use of a deformable thermal connector 9 enables at least a part of the vibrations and/or of the shock wave caused by the Stirling cooler to be absorbed. The Stirling cooler has a piston that moves to compress or expand a gas thereby obtaining production of coolant in a particular operating manner. The back-and-forth movements of the piston generate vibrations that cause a movement between the detection circuit and at least one of first optical function 6 and second optical function 7a. This vibration or shock wave results in an impairment of the quality of the image supplied by the detection system. By using deformable thermal connector 9, the image quality can be improved even though a Stirling cooler is used. In an alternative embodiment, cooler 8 is a Joule-Thomson cooler. The pressure in the Joule-Thomson cooler is preferentially comprised between 0.5 and 2 bars. The gas used is preferentially chosen from helium and argon.

The use of a thermal connector 9 that defines a second mechanical connection that is less rigid than the first mechanical connection enables the forces introduced by cooler 8 to be totally or partially eliminated. When cooler 8 vibrates due to its operation, the vibrations are transmitted less or are not transmitted to the assembly formed by cold table 3 and cold shield 5. The detection circuit can deliver a better quality image. This also reduces the influence of the thermal expansion or of the differential thermal expansion when the detection system goes from a storage temperature at high temperature, for example ambient temperature, to an operating temperature that is at lower temperature, for example a cryogenic temperature. This further reduces the forces introduced by the cooler when the detection system is subjected to rapid movements in multiple directions.

In a particular embodiment, deformable thermal connector 9 is chosen from one or more thermally dissociated metal wires, a metal fabric, a metal knit, a metal braid, a metal spring and a metal piston.

In a particular embodiment, cooler 8 can be associated with several deformable thermal connectors 9 that all have a first end connected to cooler 8 and whose opposite second ends are fixed to distinct locations of the assembly formed by cold shield 5 and cold table 3.

The thermal connection between cooler 8 and cold table 3 and/or cold shield 5 makes it possible to avoid making the cooling energy transit along the whole height of cold shield 5, but for example only over a fraction of the height of cold shield 5, for example half the height. In transient regime, the thermal constant of a part of height H is generally proportional to the square of this height (H²), in the case of cooling via one end. Cooling by an area close to the centre (H/2 for example) enables the thermal constant of the part, and therefore its cooling time, to be reduced. In the case of cooling at position H/2, the thermal constant will be divided by a factor close to 4 i.e. (1/2)².

This enables the cooling time to be reduced, i.e. the time the assembly formed by cold table 3, detection circuit 2 and cold shield 5 takes to reach a predefined temperature, preferentially the working temperature. The working temperature is the temperature as from which a control circuit authorises acquisition of an electromagnetic signal and transformation of the latter into a usable electrical signal.

To reduce the cooling time, it is preferable for the cooling power to flow easily between cooler 8 and the assembly to be cooled. The configuration is less advantageous than that of the prior art as the exchange surface is reduced to the surface of thermal connector 9. It is therefore preferable to reduce the distance that separates the assembly to be cooled and the cooler.

To reduce the cooling time (with a predefined cooling power), it is preferable to have a thermal connector 9 that has a low thermal resistance. It is also advantageous to reduce the length of thermal connector 9 as far as possible. At constant thermal resistance, the greater the length of the thermal connector, the more the cooling time increases. It is therefore advantageous to reduce the distance separating the end of cooler 8 supplying the coolant from cold table 3 and cold shield 5 to facilitate transportation of the coolant.

In a particular embodiment, cooler 8 has a salient part mounted salient from the inner surface of the at least one side wall. The salient part enables the distance separating cooler 8 and the assembly to be cooled to be reduced in comparison with a configuration where cooler 8 is in the extension of the at least one side wall.

It is particularly advantageous for the salient part to be formed by a salient stud. The salient stud is made from a good thermal conductor, for example from a metal, preferably from copper, gold or silver. Thermal connector 9, preferably deformable thermal connector 9, has one end fixed to the salient stud to facilitate transportation of the coolant. The salient stud is a good thermal conductor with respect to the cold source and the assembly to be cooled which enables the length of thermal connector 9 to be reduced.

In order to facilitate transportation of the coolant from cooler 8 and through deformable thermal connector 9, trade-offs have to be found between the thermal resistance of deformable thermal connector 9 and the rigidity of deformable thermal connector 9. Depending on the configuration of the electromagnetic radiation detection system, it may be advantageous to choose a spring, a braid, un knit, a fabric, a gusset, a piston or at least one conductive wire. It may be advantageous to combine these configurations to facilitate transportation of the coolant.

A metal wire that presents a too small cross-section will in fact be a poor thermal conductor whereas a metal wire having a too large cross-section may become too rigid and break. A braid, a knit or a fabric is formed by several threads that are joined to one another. The threads are able to move with respect to one another to provide the flexibility, but they are in contact so as not to penalise the thermal conduction. The braid, knit or fabric can represent a good trade-off between thermal conductivity and rigidity.

The use of a spring can also be envisaged. The configuration of the latter is adapted so as to achieve the best trade-off between thermal conductivity and stiffness in the operating temperature range. The spring can be a conical spring, a diaphragm spring, an annular spring, a coil spring, a leaf spring, a spiral spring or any other configuration of spring.

It is particularly advantageous to perform acquisition of the electromagnetic radiation when the assembly formed by cold table 3, detection circuit 2 and cold shield 5 has reached the working temperature. It is then advantageous to place the end of thermal connector 9 designed to be fixed to the assembly formed by cold table 3, cold shield 5 and detection circuit 2 judiciously so that the coolant covers the shortest possible distance to reach the farthest part of the assembly.

In a preferential embodiment, the second end is fixed to a central part of cold shield 5. The central part extends from the bottom third up to the top third of cold shield 5 along optical axis A of the electromagnetic radiation detection assembly formed by detection circuit 2 and cold shield 5. The configuration used in the prior art is indeed particularly disadvantageous as the coolant input via the top of the thermally insulating support has to pass through a part of the cold table and then flow back up over the whole height of the side wall of cold shield 5 to cool the top of the shield and first optical function 6. The configuration of the prior art presents a longer cooling time than those of the configurations described above with a connection on the cold shield.

In a particular embodiment, the second end is fixed to the thermal barycentre of the assembly to be cooled formed for example by cold shield 5 and cold table 3 or of the thermal assembly formed by cold shield 5, cold table 3 and detection circuit 2.

The thermal barycentre can be defined in the following manner. The thermal barycentre corresponds to a point of the assembly to be cooled that represents the minimization of the sum of the thermal constants τₜₕ. The thermal constant τₜₕ is defined in the following manner τₜₕ=Rₜₕ×Cₜₕ with
Rₜₕ: equivalent thermal resistance in transient mode of the assembly to be cooled. The thermal resistance is expressed in K/W.
Cₜₕ: equivalent thermal capacity of the part to be cooled. The thermal capacity is expressed in J/K.

In a particular embodiment, the element to be cooled is cold shield 5 and cold shield 5 has an optic through which the electromagnetic signal to be captured passes. The second end is fixed to the barycentre of cold shield 5 so that the cooling energy arrives at the same time at the optic and at cold table 4. The cooling time until the working temperature is reached is optimised.

In a particular embodiment illustrated in FIG. 2, electromagnetic radiation detection system 1 is equipped with an additional cooler 8 connected to the assembly formed by cold shield 5, detection circuit 2 and cold table 3 by an additional thermal connector 9.

Additional thermal connector 9 is advantageously a deformable thermal connector according to one of the configurations described in the above. Additional cooler 8 can be a Stirling cooler or a Joule-Thomson cooler.

In the illustrated embodiment, cooler 8 is connected to the bottom part of cold shield 5 or to cold table 3 and additional cooler 8 is connected to the top part of cold shield 5. The assembly formed by cold table 3, detection circuit 2 and cold shield 5 is cooled by two coolers that are connected at two different places.

In the embodiment illustrated in FIG. 2, the two coolers are respectively connected to the top of cold shield 5 and to cold table 3 to cool the shield via its two opposite ends. An alternative configuration is also possible with additional cooler 8 connected at a distance from the top of cold shield 5 and cooler 8 connected in the bottom part of the cold shield.

In a particular embodiment, cooler 8 and additional cooler 8 operate and stop simultaneously. In another embodiment, cooler 8 and additional cooler 8 are activated simultaneously to perform cooling of detection system 1. Once the cooling has been achieved, i.e. the working temperature has been reached, the additional cooler stops. Cooler 8 can on its own provide the cooling power necessary to keep the detection system at the working temperature during its operation. In such a configuration, it is advantageous to use an additional cooler 8 of Joule-Thomson type.

Cooler 8 can be a Stirling cooler or a Joule-Thomson cooler that has a higher cooling power than the cooling power of the additional cooler.

As the mechanical constraints on thermally insulating support 4 have been lessened, it is possible to form a thermally insulating support that is more thermally insulating which enables the power of cooler 8 to be reduced for an identical result thereby enabling its size to be reduced. It is also possible to reduce the height of thermally insulating support 4.

Detection system 1 is provided with a line connected on the one hand to detection circuit 2 and on the other hand to a processing circuit (not illustrated) arranged outside cryostat 7. The line performs transmission of the electrical signal outside cryostat 7. Thermal connector 9 does not participate in transmission of an electrical signal. Thermal connector 9 may be grounded.

As cooler 8 is no longer connected directly to thermally insulating support 4, the bottom of cryostat 7 can be formed by a single part thereby improving the tightness.

Cryostat 7 is at high temperature and is only connected to cold table 3 via thermally insulating support 4 that forms a thermal resistance in order to limit the cooling loss via this channel. A large freedom exists in the choice of the material forming the cryostat and in particular the side wall in order to support the weight of cooler 8 and of the additional cooler if present. Cooler 8 is mainly located outside cryostat 7. The side wall of cryostat 7 has a hole enabling the cold area of cooler 8 to enter the volume of cryostat 7.

FIG. 1 illustrates an electromagnetic radiation detection system equipped with a single cooler and FIG. 2 illustrates an electromagnetic radiation detection system with two coolers. It is possible to increase the number of coolers to increase the number of cooling energy input points on the assembly formed by cold table 3, detection circuit 2 and cold shield 5. However, increasing the number of coolers increases the overall size of the detection system.

In the particular embodiments illustrated, cold shield 5 has an additional optical function 11 arranged between first optical function 6 and detection circuit 2. It is advantageous to connect thermal connector 9 close to additional optical function 11 or in the plane perpendicular to optical axis 1 that contains additional optical function 11. Additional optical function 11 is mounted on a support 12.

In a particular embodiment, the detection system is an on-board detection system for example a detection system designed to be installed on a vehicle which implies increased technical constraints on the alignment of the different optical functions and of detection circuit 2 with respect to the optical axis. The detection system can be installed in an airplane, a helicopter, a car or any other vehicle subjected to abrupt movements. II is also possible for the detection system to be carried by a person which increases the size and weight management constraints.

FIGS. 1 and 2 illustrate a particular embodiment where the cooler is fixed onto the side wall of cryostat 7. This configuration enables the heightwise dimension to be reduced, i.e. in the direction of optical axis A, which can facilitate integration of the detection system in equipment where the space occupation in this dimension is limited.

In a preferred embodiment, cold table 3 is mounted fixedly with respect to enclosure 7 solely by means of thermally insulating support 4. The use of a single part enables immobile installation of the cold table inside enclosure 7 to be managed more easily.

It is also advantageous to provide for thermally insulating support 4 to present an annular shape in a cutting plane perpendicular to the optical axis, the optical axis passing through the annular shape. The cold shield, detection device, cold table and thermal insulating support 4 are arranged consecutively along the optical axis which enables the lateral space occupation of the detection system to be limited.

In preferred manner, thermally insulating support 4 presents an annular shape in a cutting plane perpendicular to the optical axis, the optical axis passing through the annular shape. As thermally insulating support 4 is substantially in the extension of detection circuit 2 and cold shield 4, it is easier to mount cold table 3 fixedly inside enclosure 7.

1.-14. (canceled)

15. Electromagnetic radiation detection system comprising:
an enclosure provided with a wall with a bottom, a top and at least one side wall connecting the bottom and the top, the enclosure being closed and tightly sealed,
a detection circuit configured to detect an electromagnetic radiation and to supply an electrical signal representative of the detected electromagnetic radiation,
a cooler fixed to the enclosure and configured to cool the detection circuit, the cooler being of Joule-Thomson or Stirling type,
a cold table supporting the detection circuit,
a cold shield fixed to the cold table,
a support configured to fit the cold table fixedly with respect to the enclosure, the support defining a first mechanical connection between the cold table and the wall of the enclosure, the support being fixed to the enclosure independently from the cooler,
a thermal connector having a first end fixed to the cooler and a second end fixed to the cold table or to the cold shield so that the cooler cools the detection circuit,
wherein the detection circuit, the cold table, the cold shield and support are arranged in the enclosure,
wherein
the thermal connector is a deformable thermal connector that defines a flexible mechanical connection between the cooler and the cold table or to the cold shield,
the support is a thermally insulating support that thermally insulates the cold table with respect to the wall of the enclosure and the support is separated thermally from the thermal connector at least by the cold table.

16. Electromagnetic radiation detection system according to claim 15, wherein the second end is fixed to a central part of the cold shield, the central part extending from the bottom third up to the top third of the cold shield along an optical axis of an electromagnetic radiation detection assembly formed by the detection circuit and the cold shield.

17. Electromagnetic radiation detection system according to claim 15, wherein the cooler has a first end capped by a salient metal stud, the thermal connector being attached to the salient metal stud, the salient metal stud of the cooler being fitted salient from the inner surface of the side wall of the enclosure and thermally insulated from the enclosure.

18. Electromagnetic radiation detection system according to claim 15, wherein the deformable thermal connector is chosen from a spring, a braid, a knit, a fabric, a gusset, a piston or at least a wire made of metal.

19. Electromagnetic radiation detection system according to claim 15, wherein the deformable thermal connector is connected directly to the cold shield.

20. Electromagnetic radiation detection system according to claim 15, wherein an additional cooler is fastened to the at least one side wall of the enclosure and an additional deformable thermal connector thermally connects one end of the additional cooler and the top of the cold shield, the deformable thermal connector being fixed to the cold table or in the bottom half of the cold shield extending from the cold table.

21. Electromagnetic radiation detection system according to claim 19, wherein the cooler is a Stirling cooler.

22. Electromagnetic radiation detection system according to claim 20, wherein the cooler is a Stirling cooler

23. Electromagnetic radiation detection system according to claim 19, wherein the cooler is a Joule-Thomson cooler.

24. Electromagnetic radiation detection system according to claim 20, wherein the cooler is a Joule-Thomson cooler.

25. Electromagnetic radiation detection system according to claim 15, wherein the thermal conductivity of the thermally insulating support is lower than the thermal conductivity of the deformable thermal connector.

26. Electromagnetic radiation detection system according to claim 15, wherein the thermally insulating support is apertured and/or the connection between the thermally insulating support and the cold table is not tightly sealed.

27. Electromagnetic radiation detection system according to claim 15, wherein the thermally insulating support separates the detection circuit and the bottom of the enclosure along an optical axis of the detection circuit.

28. Electromagnetic radiation detection system according to claim 15, wherein the thermally insulating support presents an annular shape in a cutting plane perpendicular to the optical axis, the optical axis passing through the annular shape.

29. Electromagnetic radiation detection system according to claim 15, wherein the cold table is mounted fixedly with respect to the enclosure solely by means of the thermally insulating support.

30. Method for cooling an electromagnetic radiation detection system comprising the following steps:
providing an electromagnetic radiation detection system according to claim 15,
activating the cooler to cool the detection circuit.
